(19) United States
(12) Patent Application Publication
(10) Pub. No.: US 2016/0325911 A1
(43) Pub. Date: Nov. 10, 2016

(54) ANTIMICROBIAL COMPOSITIONS FOR FOOD PACKAGING CONSISTING OF SALICYLALDEHYDE AND CARVACROL, THYMOL OR THEIR MIXTURE

(71) Applicant: INSTITUTO TECNOLÓGICO DEL EMBALAJE, TRANSPORTE Y LOGÍSTICA, Paterna (ES)

(72) Inventors: Ana Guadalupe GALET DOMINGO, Paterna (ES); Luís PRATS GARCÍA, Paterna (ES); Fuensanta Maria MONEDERO PRIETO, Paterna (ES); José María BERMÚDEZ SALDAÑA, Paterna (ES); Maria Teresa CALVO VILANONA, Paterna (ES); Marta Inés LARA LLEDÓ, Paterna (ES)

(73) Assignee: INSTITUO TECHNOLOGICO DEL EMBALAJE TRANSPORTE Y LOGISTICA (ITENE), Patema (ES)

(21) Appl. No.: 15/111,468

(22) PCT Filed: Jan. 14, 2015
(86) PCT No.: PCT/EP2015/050613

§ 371 Date: Jul. 13, 2016

(30) Foreign Application Priority Data
Jan. 14, 2014 (EP) 14151079.2

(51) Int. Cl. B65D 81/28; A01N 35/04; A01N 25/10; A01N 31/08

(52) U.S. Cl. CPC B65D 81/28; A01N 31/08; A01N 35/04; A01N 25/10

(57) ABSTRACT

Antimicrobial compositions for organic product packaging The invention relates to an antimicrobial combination for food packaging consisting of: i) salicylaldehyde; ii) carvacrol, thymol or a mixture thereof; and in some embodiments iii) other components and excipients devoid of any antimicrobial activity. The invention relates further to an active coating for food packaging comprising a polymeric matrix and said antimicrobial combination, to a package comprising said active coating, to a process for producing it and to uses thereof.

### FIELD OF INVENTION

The present invention relates to compositions having antimicrobial properties to be used in active packaging of organic product such as food products, and in particular of meat-based products. The packaging materials endowed with these compositions have multiple applications, especially in the food industry.

### BACKGROUND ART

The food industry is under high pressure from both consumer societies and regulatory agencies with regard to product safety. Higher and higher standards are being implemented, and this demands in turn more stringent procedures for the production, distribution and packaging of all sorts of foods. This is especially important for meat-based products which, if not handled and packaged properly, can be a cause of dangerous food poisoning.

To minimize the risk of food poisoning due to microbial contamination and in order to extend the shelf-life of meat-based products, a number of strategies can be implemented. One of the most widely spread is the use of freshness-enhancing products and compositions in the packaging processes and materials. The technologies involved in incorporating active ingredients in the packaging materials are overall known as “active packaging”. This is a fast-moving discipline, and the packaging industry is devoting more and more resources to evolve current technologies.

The main goal of active packaging is to maintain product quality and to extend shelf life by incorporating components with certain chemical and biological activities in the packaging materials. These active components can either be: i) coated or impregnated on the packaging materials; ii) incorporated (interspersed) into them or iii) immobilized on their surfaces. In the first two cases, the components could migrate from the packaging material to the packaged food where they carry out their beneficial effects, whereas in the third, the components do not migrate and cause their effect even though they remain bound to the package.

The active components can exert their effects by a number of ways such as scavenging oxygen so that meat deterioration is slowed-down and its colour is preserved for longer periods, controlling moisture, adding flavours or by having bactericidal or bacteriostatic properties.

With regard to the latter property, a diverse number of antimicrobial components have been experimentally tested and some of them industrially implemented in active packaging (see for instance Quintavalla S. et. al. “Antimicrobial food packaging in meat industry” Meat Science 2002, vol. 62, pp. 373-380). Thus, compounds ranging from organic acids such as sorbate or propionate, through bacteriocins such as nisin, enzymes such as lysozyme and fungicides such as imazalil have been used. The discovery of new compositions to be used in the active packaging of meat is an active area of research.

Remarkably, one of the most successful sources of active compounds and compositions are natural products derived from plants and plant extracts. Essential oils such as rosemary and oregano oil (and some of their constituents) have been used for some time as antimicrobial compounds in active packaging (see for instance Gutiérrez L., et. al. “Effect of mixed antimicrobial agents and flavors in active packaging films” J. Agric. Food Chem. 2009, vol. 57, pp. 8564-8571). Some of the most notorious examples of plant-derived compounds exploited in active packaging are thymol, eugenol, cynnamaldehyde, carvacrol and menthol. Many of these compounds can be incorporated in films coating any polymer packaging, and can be expected to gradually migrate from the organic film to the packaged food in order to exert their antimicrobial effects (see for instance Gutierrez L. et. al. “New approach to study the mechanism of antimicrobial protection of an active packaging” FoodBorne Pathogens and Disease 2010, vol. 7, n. 9, pp. 1063-1069).

Although these plant-derived compounds are widely used in antimicrobial active packaging, they are not devoid of limitations. Some are not potent enough to be used in very small quantities and therefore have to be added in high concentrations. Some, because of their highly volatile nature and strong flavour, can accumulate and potentially confer undesirable taste and odours to the packaged meat. Some, because of their intrinsic chemical instability are not applicable in active packaging. Others have high potency only for certain food-borne pathogenic bacteria such as gram-negative or gram-positive bacteria, and therefore do not display a spectrum that is broad enough for general use. Related to the latter, some pathogenic bacteria capable of colonizing packaged food, such as Psedomonas aeruginosa, seem to be very resistant to several antimicrobial compositions described.

Therefore there is a need in the art to find new compositions with higher antimicrobial potencies at very low concentrations and wider antimicrobial spectra to improve the current active packaging materials. These new compositions should be able to slow down the deterioration and oxidation of packaged organic product (in particular packaged food) due to the presence of microorganisms, thus helping to preserve its nutritional composition, its colour and its organoleptic properties.

### SUMMARY OF THE INVENTION

Inventors have found that the combination of 2 and 3 plant-derived compounds has a marked synergistic antimicrobial activity that can be exploited in food packaging, and in general for packaging of organic product susceptible of being colonized by microorganisms.

In particular, the combinations are salicylaldehyde and either carvacrol or thymol, and salicylaldehyde plus carvacrol and thymol. These combinations have been found to be very potent on both gram-positive and gram-negative bacteria, ensuring a wide applicability in active packaging.

The potency of this combinations guarantees that smaller amounts of the antimicrobial compound mixture are used in active packaging substrates, which ensures: i) the active packaging materials are more convenient in terms of overall manufacturing costs; ii) the accumulation of volatile compounds in the packaged food is minimized, thereby also minimizing any potential undesirable flavours, because the effective antimicrobial concentration used in the films is lower due to their synergistic antimicrobial activity.

Surprisingly, carvacrol and thymol have no synergy at the tested concentrations and under the conditions used by the inventors. Thus, some essential-oil derived compounds do not have any remarkably improved properties in terms of antimicrobial potency when combined. This is not the case for the composition object of the present invention, as the antimicrobial potency of thymol and carvacrol is greatly boosted when combined with salicylaldehyde, as the experimental data provided herein supports. In addition, combinations of thymol and salicylaldehyde and combinations of carvacrol and salicylaldehyde have also shown synergism at specific ratios.

Thus, a first aspect of the present invention relates to an antimicrobial composition for organic product packaging selected from the group consisting of:

a) a combination consisting of carvacrol, thymol and salicylaldehyde;

b) a combination consisting of thymol and salicylaldehyde at a ratio thymol:salicylaldehyde of from 1:2 to 1:9 in weight;

c) a combination consisting of carvacrol and salicylaldehyde at a ratio carvacrol:salicylaldehyde of from 1:2 to 1:9 in weight;

d) a combination consisting of carvacrol, thymol, salicylaldehyde, and other components and/or excipients devoid of any antimicrobial activity;

e) a combination consisting of thymol, salicylaldehyde at a ratio thymol:salicylaldehyde of from 1:2 to 1:9 in weight, and other components and/or excipients devoid of any antimicrobial activity; and

f) a combination consisting of carvacrol, salicylaldehyde at a ratio carvacrol:salicylaldehyde of from 1:2 to 1:9 in weight; and other components and/or excipients devoid of any antimicrobial activity.

In the present invention, the terms combination and composition are interchangeable and taken to have the same meaning.

In particular, the antimicrobial composition is suitable for organic product packaging of organic products susceptible of being colonized by microbes.

A second aspect of the present invention is an active formulation for organic product packaging comprising a polymeric matrix and the antimicrobial composition of the first aspect of the invention.

A third aspect is an organic product packaging substrate coated with the active formulation of the second aspect of the invention.

A fourth aspect is an organic product package comprising the organic product packaging substrate of the third aspect of the invention.

A fifth aspect is a process for preparing the active formulation of the second aspect of the invention, comprising:

a1) providing a polymer matrix and optionally dissolving the polymeric matrix in at least one solvent;

a2) Optionally, incorporating at least one plasticiser;

a3) Optionally incorporating at least one anti-fog compound; and

a4) Incorporating the antimicrobial combination of the first aspect of the invention.

A sixth aspect is a process for preparing the organic product packaging substrate of the third aspect of the invention, comprising the steps of:

a) Optionally treating the surface of the organic product packaging substrate, to be coated with the active formulation, with a corona treatment;

b) Applying the active formulation to the organic product packaging substrate by coating, impression, dipping or spraying; and

c) Drying the organic product packaging substrate.

A seventh aspect is the use of the active formulation of the second aspect of the invention, for extending the shelf-life of organic product susceptible of being colonized by microbes.

### BRIEF DESCRIPTION OF THE DRAWINGS

FIG. 1. Effect of active films on aerobic mesophiles and enterobacteriaceae growth in fresh beefsteaks. Control: fresh beefsteaks packaged with conventional high barrier materials. ACTIVE 50: fresh beefsteaks packaged with conventional high barrier materials and films, coated with active coating. ACTIVE 100: fresh beefsteaks packaged with conventional high barrier materials and films, coated with active formulation at dose 2×.

FIG. 2. Effect of active films on lipid oxidation in fresh beefsteaks. PRIMARY LIPIDIC OXIDATION. Test TBA: measure of malonaldehide levels. SECODARY LIPIDIC OXIDATION. measure of hexanal levels. Control: fresh beefsteaks packaged in conventional high barrier materials. ACTIVE 50: fresh beefsteaks packaged in conventional high barrier materials and films, coated with active coating. ACTIVE 100: fresh beefsteaks packaged in conventional high barrier materials and films, coated with active formulation at dose 2×.

FIG. 3. Color evolution of the fresh beefsteaks in coated (ACTIVE) and non-coated packages (CONTROL). The figure clearly shows significative differences in color between the control an active films since day 12.

### DETAILED DESCRIPTION OF THE INVENTION

For the sake of understanding, the following definitions are included.

The term “antimicrobial combination” as used herein refers to a combination of chemical compounds (a chemical composition) that inhibit the growth or kill any microbial organism such as bacteria, fungi, yeasts, and any other microorganism that can contaminate and deteriorate the packaged organic product, such as food. With regard to the biological activity against bacteria, the antimicrobial compounds forming the combination can be bacteriostatic and/or bactericidal.

The term “optionally comprising other components and/or excipients devoid of any antimicrobial activity” as used herein refers to the fact that the antimicrobial combination of the invention can have added components which are not endowed of antimicrobial activity themselves, but which boost the antimicrobial activity of the combination.

The term “corona treatment” as used herein refers to a surface modification technique that uses a low temperature corona discharge plasma to impart changes in the properties of a surface, in this case the surface of a packaging material.

The term “solvent suitable for food contact” as used herein refers to any solvent that can be used safely in the manufacture of plastics and other materials which come into contact with food for human consumption. The solvent must be harmless and devoid of any toxic properties.

The term “antimicrobial combination is interspersed in the polymeric matrix” as used herein refers to the fact that the compounds of the antimicrobial combination (that is carvacrol, thymol and salicylaldehyde) are, once added to the polymeric matrix, at least in part distributed and scattered inside the polymer, so that they are released in a controlled fashion to the cavity where the packaged food is kept.

The term “plasticiser” as used herein refers to a product that allows the adhesion of the active formulation to a substrate. A product that makes the polymer less brittle; enhancing the flexibility and mobility of the polymeric chain. A list of plasticisers suitable for carrying out the invention follows: Phthalate-based plasticizers, Adipate-based plasticizers, Benzoates, Terephthalates, Epoxidized vegetable oils, alkyl sulphonic acid phenyl ester (ASE), Sulfonamides, Organophosphates and Glycols/polyethers. Among these, preferred plasticisers are tert-butyl citrate, polyadipate or glycerol.

The term “antifog” as used herein refers to chemicals that prevent the condensation of water in the form of small droplets on a surface. A list of antifog agents suitable for carrying out the invention follows: Non-ionic surfactants like polyhydric alcohol fatty acid esters, higher fatty acid amines, higher fatty acid amides, polyoxyethylene ethers of higher fatty alcohols, polyoxyethylene glycols of higher fatty acids and ethylene oxide adducts of higher fatty acid, amines, or amides and their admixtures are meant. Among these, preferred antifog agents are polyhydric alcohol fatty acid esters, especially sorbitan derivatives, polyoxyethylene glycols of higher fatty acids and glycerin fatty acid esters and their admixtures.

The term “active formulation” as used herein refers to the result of combining the antimicrobial composition of the invention with a polymeric matrix. A list of the possible polymers to be used for carrying out the invention follows:
Thermoplastic polymers: polyesters, EVA, EAA, EMA, EMMA, EMAA, PLA, PHAs, PHBs, starch (modified or not), PCL, polyolefins such as PE, PP (homo and copolymers, modified or not),
Thermosetting polymers: Polyurethanes, Melamine resin, Epoxy, Polyester resins.

Out of these two groups, thermoplastic polymers are preferred, especially sealant resins, such as PE-based, PP-based, EVA copolymers, PLA-based, Polystyrene-based.

As stated above, a first aspect of the present invention relates to an antimicrobial composition for organic product packaging selected from the group consisting of:

a) a combination consisting of carvacrol, thymol and salicylaldehyde;

b) a combination consisting of thymol and salicylaldehyde at a ratio thymol:salicylaldehyde of from 1:2 to 1:9 in weight;

c) a combination consisting of carvacrol and salicylaldehyde at a ratio carvacrol:salicylaldehyde of from 1:2 to 1:9 in weight;

d) a combination consisting of carvacrol, thymol,salicylaldehyde, and other components and/or excipients devoid of any antimicrobial activity;

e) a combination consisting of thymol, salicylaldehyde at a ratio thymol:salicylaldehyde of from 1:2 to 1:9 in weight, and other components and/or excipients devoid of any antimicrobial activity; and

f) a combination consisting of carvacrol, salicylaldehyde at a ratio carvacrol:salicylaldehyde of from 1:2 to 1:9 in weight; and other components and/or excipients devoid of any antimicrobial activity.

In a particular embodiment of the first aspect of the invention, the antimicrobial composition for organic product packaging of the first aspect is the combination of carvacrol, thymol and salicylaldehyde; or the combination of carvacrol, thymol, salicylaldehyde, and other components and/or excipients devoid of any antimicrobial activity.

In a particular embodiment of the first aspect of the invention, the antimicrobial composition for organic product packaging of the first aspect is the combination of thymol and salicylaldehyde at a ratio thymol:salicylaldehyde of from 1:2 to 1:9 in weight; or the combination is thymol and salicylaldehyde at a ratio thymol:salicylaldehyde of from 1:2 to 1:9 in weight, and other components and/or excipients devoid of any antimicrobial activity.

In a particular embodiment of the first aspect of the invention, the antimicrobial composition for organic product packaging of the first aspect is the combination of carvacrol and salicylaldehyde at a ratio carvacrol:salicylaldehyde of from 1:2 to 1:9 in weight; or the combination is cavacrol and salicylaldehyde at a ratio carvacrol:salicylaldehyde of from 1:2 to 1:9 in weight, and other components and/or excipients devoid of any antimicrobial activity.

In a particular embodiment of the first aspect of the invention, the antimicrobial composition of the first aspect has a concentration of carvacrol:thymol:salicylaldehyde of:
carvacrol from 5% to 50%;
thymol from 3% to 20%; and
salicylaldehyde from 28% to 90%,
in weight with respect to the total concentration of carvacrol, thymol and salicylaldehyde.

In a particular embodiment of the first aspect of the invention, the antimicrobial composition of the first aspect has a concentration of carvacrol:thymol:salicylaldehyde of:
carvacrol from 11% to 42%;
thymol from 5% to 17%; and
salicylaldehyde from 41% to 82%,
in weight with respect to the total concentration of carvacrol, thymol and salicylaldehyde.

Preferably the organic product of any of the previous embodiments is food, being the antimicrobial formulation suitable for food packaging.

In a particular embodiment, the antimicrobial combination for food packaging consists of carvacrol, thymol and salicylaldehyde, optionally comprising other components and/or excipients devoid of any antimicrobial activity.

In another particular embodiment, the antimicrobial combination for food packaging consists of thymol and salicylaldehyde, optionally comprising other components and/or excipients devoid of any antimicrobial activity.

In another particular embodiment, the antimicrobial combination for food packaging consists of carvacrol and salicylaldehyde optionally comprising other components and/or excipients devoid of any antimicrobial activity.

As has also been cited above, the second aspect of the invention is an active formulation for organic product packaging comprising a polymeric matrix and the antimicrobial composition of the first aspect of the invention.

In a particular embodiment of the second aspect of the invention the polymeric matrix comprises polysterene, polylactic acid, ethylene-vinyl-alcohol, polyamides, polyolefins, celluloses, waxes, paraffins, or a mixture thereof.

In a particular embodiment of the second aspect of the invention the antimicrobial composition is interspersed in the polymeric matrix.

In a particular embodiment of the second aspect of the invention the active formulation is an active coating for food packaging.

Particularly, the previous active coating for food packaging comprises a polymeric matrix and an antimicrobial combination of compounds which comprises at least the antimicrobial combination of the first aspect of the invention.

More particularly, the previous active coating for food packaging comprises a polymeric matrix and an antimicrobial combination of compounds consists of the antimicrobial combination of the first aspect of the invention.

In a particular embodiment, the active coating for food packaging has a ratio of concentrations of carvacrol:thymol:salicylaldehyde from 1:0.5:7 to 3:1.5:11 in weight.

More particularly, the active coating for food packaging has a ratio of concentrations of carvacrol:thymol:salicylaldehyde from 1.5:0.8:8 to 2.5:1.2:10 in weight.

As has also been cited above, the third aspect of the invention is an organic product packaging substrate coated with the active formulation of the second aspect of the invention.

In a particular embodiment of the third aspect of the invention the organic product packaging substrate is a lid, a tray, a film, a paper, a bag, or a pad.

As has also been cited above, the fourth aspect of the invention is an organic product package comprising the organic product packaging substrate.

In a particular embodiment of the fourth aspect, the organic product package is a food package.

In a particular embodiment, the food package is coated with the active coating. The food package can be of any type, either flexible, rigid, or both, and in any form or size, such as trays, boxes, tags, pads or films.

In a particular embodiment, the food package comprises any polymeric material or any paper-based material, or a mixture thereof.

It also forms part of the invention a fifth aspect, which is a process for preparing the active formulation of the second aspect of the invention, comprising:

a1) providing a polymer matrix and optionally dissolving the polymeric matrix in at least one solvent;

a2) Optionally, incorporating at least one plasticiser;

a3) Optionally incorporating at least one anti-fog compound; and

a4) Incorporating the antimicrobial combination of the first aspect of the invention.

In a particular embodiment of the of the fifth aspect of the invention, in step a2) it is incorporated a plasticiser.

In a particular embodiment of the fifth aspect of the invention, in a2) the at least one plasticiser is tert-butyl citrate, polyadipate or glycerol.

In a particular embodiment, the active formulation is an active coating for food packaging and the solvent used in step a1) of the process is a solvent suitable for food contact.

It is also part of the invention an active formulation, in particular, an active coating obtainable by the process described above, including any of the particular embodiments mentioned.

In a particular embodiment of the fifth aspect of the invention, in step a3) the at least one anti-fog compound is sodium lauryl sulphate, glycerol or an ethoxy-amine.

It also forms part of the invention a sixth aspect, which is a process for preparing the organic product packaging substrate of the third aspect of the invention, comprising the steps of:

a) Optionally treating the surface of the organic product packaging substrate, to be coated with the active formulation, with a corona treatment;

b) Applying the active formulation to the organic product packaging substrate by coating, impression, dipping or spraying; and

c) Drying the organic product packaging substrate.

In a particular embodiment of the sixth aspect of the invention, in step b), the coating comprises roller printing, flexography, ink jet printing or rotogravure.

In a particular embodiment of the sixth aspect of the invention, the formulation is deposited on the whole surface of the substrate, or alternatively, only on some areas of the surface of the substrate.

In another particular embodiment, the deposition can follow certain patterns, which might be regular or irregular.

It is also part of the invention an organic product packaging substrate obtainable by the process described above, including any of the particular embodiments mentioned.

The food package of the invention may be prepared by a process comprising the steps of:

a) Treating the surface of the food package, to be coated with the active coating of the invention, with a corona treatment;

b) Applying the active coating to the food package by lamination, impression or spraying; and

c) Drying the food package.

In a particular embodiment, the process for preparing the food package further comprises first preparing the active coating of the invention by a process comprising:

a1) Dissolving the polymeric matrix in at least one solvent suitable for food contact;

a2) Incorporating at least one plasticiser;

a3) Incorporating at least one anti-fog compound; and

a4) Incorporating the antimicrobial combination of the first aspect of the invention.

It is also part of the invention a food package coated with the active coating of the invention, obtainable by the process described above, including any of the particular embodiments mentioned.

It also forms part of the invention a seventh aspect, which is the use of the active formulation of the second aspect of the invention, in particular the active coating, for extending the shelf-life of organic product susceptible of being colonized by microbes.

In a particular embodiment of the seventh aspect of the invention, the organic product susceptible of being colonized by microbes is a food.

In a particular embodiment of the seventh aspect of the invention, the organic product susceptible of being colonized by microbes is a meat-based product.

Throughout the description and claims the word “comprise” and variations of the word, are not intended to exclude other technical features, additives, components, or steps. Furthermore, the word “comprise” and its variations encompasses the term “consisting of”. Additional objects, advantages and features of the invention will become apparent to those skilled in the art upon examination of the description or may be learned by practice of the invention. The following examples are provided by way of illustration, and they are not intended to be limiting of the present invention. Furthermore, the present invention covers all possible combinations of particular and preferred embodiments described herein.

### EXAMPLES

### Example 1

### Antimicrobial Composition/Combination. Synergy Assays

1—Materials and Methods

1.1 Reference Microorganisms

Solutions containing carvacrol, thymol and salicylaldehyde were assessed for antimicrobial activity against three different reference microorganisms:
Gram negative bacteria—Escherichia coli (strain ATCC 8739)
Gram negative bacteria—Pseudomonas aeruginosa (strain ATCC 27853)
Gram positive bacteria—Staphylococcus aureus (strain ATCC6538)

The microorganisms were collected from the “Colección Española de Cultivos Tipo” (CECT), University of Valencia. They were collected in the form of a lyophilized inoculum and were refreshed by regular seeding in solid culture media. After the grown, the stock culture was kept under refrigeration. Prior to the analysis, the microorganisms were recultured 3-4 times by diluting colonies in tryptic soy broth (TSB) and incubating overnight at 36° C.

1.2 Preparation of the Inoculum

The day prior to the assay, the colonies are touched with a loop and transferred to tryptic soy broth (TBS) (100 mL). The broth is incubated at 36° C. overnight until the growth reaches a turbidity equal or similar to 10⁹ colony-forming units per millilitre (CFU/mL). The culture is adjusted to give a turbidity equivalent to 0.18 absorbance units in order to confirm the inoculum is in the exponential growth phase (around 10⁵-10⁶ CFU/mL). The measurement is carried out by using a UV-VIS spectrometer, operating at 550 nm and a 1-cm path cell.

1.3 Antimicrobial Agents.

Standards of carvacrol (>98%) and thymol (>99.5%) were obtained from Sigma Aldrich Inc. (St. Louis, Mo.). In addition, salicylaldehyde (>99%) was supplied by Scharlab, Barcelona, Spain.

Preparation of Carvacrol, Thymol and Salicylaldehyde Solutions.

Concentration of antimicrobial stock solutions were 250 mg/mL for thymol, 250 and 500 mg/mL for the carvacrol, and 1000 mg/mL for salicylaldehyde, using isopropyl alcohol (IPA) as a solvent. Working solutions were immediately prepared by using the stock solutions in order to avoid the deterioration of the antimicrobial compounds. For full-range MIC testing, each series were prepared with at least 10 levels of concentration added by using isopropyl alcohol (IPA) as a solvent.

1.4 Inoculation and Incubation of Tubes

Each test level of antimicrobial blend was prepared by adding a volume of the inoculum (bacterial suspension described in section 1.2), and the same volume of the corresponding antimicrobial solution to a tube containing 10 mL of sterilized TSB.

After the inoculation, tubes were incubated for 20 h at 36° C.

Positive and negative controls were included as reference samples, that is, inoculated samples including IPA without antimicrobial agents as positive controls, and no inoculated antimicrobials agents free samples, as negative controls.

1.5 Synergy Index Calculation

The antimicrobial efficacy of Carvacrol, Thymol and Salycylaldehyde and their blends, was determined as Minimum Inhibitory Concentration (MIC). MIC is recorded as the lowest product concentration that inhibits growth.

The synergy index (SI) calculation is based on the equation 1:

$$SI = {\sum }_{i = 1}^{n} \frac{{CM}_{n}}{{CS}_{n}}$$

Where:
CM is the MIC of the substance n when used in a blend, that is, in combination with the rest of antimicrobial compounds analysed.
CS is the MIC of the substance when used alone.

SI below 1 indicates synergy effect and p-value has been calculated as the probability of obtaining the observed sample results (or a more extreme result) when the null hypothesis is actually true. If this p-value is <0.05 means that there is a significant difference between the SI value and 1.00.

2—Results

A wide range of different blends of Carvacrol, Thymol and Salicylaldehyde was tested and compared to the antimicrobial activity of each antimicrobial compound in order to assess their antimicrobial activity against the gram negative bacteria Escherichia coli and Pseudomonas aeruginosa, and gram positive bacteria Staphylococcus aureus. The different treatments were tested in triplicate.

Table 1 summarizes the different antimicrobial combinations of Carvacrol, Thymol and Salicylaldehyde tested against Escherichia coli, Pseudomonas aeruginosa, and Staphylococcus aureus.

TABLE 1
Antimicrobial combinations of Carvacrol, Thymol and Salicylaldehyde
(binary and ternary blends) tested against Escherichia coli,
Pseudomonas aeruginosa, and Staphylococcus aureus.

| | Composition (proportion) | | | Composition (percentage) | | |
|---|---|---|---|---|---|---|
| | Carva- | Thy- | Salicylal- | Carva- | Thy- | Salicylal- |
| | crol | mol | dehyde | crol | mol | dehyde |
| BINARY | 3 | | 8 | 27.27 | | 72.73 |
| BLENDS | 1 | | 5 | 17 | | 83 |
| | 1 | | 9 | 10 | | 90 |
| | 2 | | 3 | 40 | | 60 |
| | | 1 | 5 | 17 | | 83 |
| | | 1 | 9 | 10 | | 90 |
| | | 1 | 8 | | 11.11 | 88.89 |
| TERNARY | 3 | 1 | 8 | 25 | 8.33 | 66.67 |
| BLENDS | 1 | 0.5 | 7 | 11.76 | 5.88 | 82.35 |
| | 3 | 1.5 | 11 | 19.35 | 9.68 | 70.97 |
| | 3 | 1.5 | 14 | 16.22 | 8.11 | 75.68 |
| | 5 | 2 | 5 | 41.67 | 16.67 | 41.67 |
| | 3 | 2 | 14 | 15.79 | 10.53 | 73.68 |
| | 3.5 | 1.5 | 11 | 21.88 | 9.38 | 68.75 |
| | 3.5 | 2.5 | 14 | 17.5 | 12.5 | 70 |
| | 3 | 2 | 1 | 50 | 33.33 | 16.67 |
| | 3 | 1 | 4 | 37.5 | 12.5 | 50 |
| | 4 | 1 | 2 | 57.14 | 14.29 | 28.57 |
| | 4 | 1 | 7 | 33.33 | 8.33 | 58.33 |
| | 5 | 0.5 | 7.5 | 38.46 | 3.85 | 57.69 |

The antimicrobial efficacy of Carvacrol, Thymol and Salycylaldehyde and their blends, was determined as Minimum Inhibitory Concentration (MIC) and the Synergistic Index calculation (see point 1.5). MIC is recorded as the lowest product concentration that inhibits growth.

MIC values obtained for each compound and blends against the selected bacteria are shown in Table 2.

The antimicrobial efficacy of binary blends against Escherichia coli, Pseudomonas aeruginosa, and Staphylococcus aureus and the different combinations is represented in table 3. Synergistic effect has been recorded by Synergistic Index calculation.

The antimicrobial efficacy of ternary blends against Escherichia coli, Pseudomonas aeruginosa, and Staphylococcus aureus and the different combinations is represented in table 4. Synergistic effect has been recorded by Synergistic Index calculation.

TABLE 2
MIC values for Carvacrol, Thymol and Salycylaldehyde (products alone and blends)

| | | | | MIC StaphylococCus aureus | | | MIC Escherichia coli | | | MIC Pseudomonas aeruginosa | | |
|---|---|---|---|---|---|---|---|---|---|---|---|---|
| | Composition (proportion) | | | (mg) | | | (mg) | | | (mg) | | |
| | Carva- | Thy- | Salicylal- | Carva- | Thy- | Salicylal- | Carva- | Thy- | Salicylal- | Carva- | Thy- | Salicylal- |
| | crol | mol | dehyde | crol | mol | dehyde | crol | mol | dehyde | crol | mol | dehyde |
| PRODUCTS | 1 | | | 2.1 | | | 3 | | | 7.5 | | |
| ALONE | | 1 | | | 1.1 | | | 2 | | | 4.5 | |
| | | | 1 | | | 4.75 | | | 4.75 | | | 2.25 |
| BINARY | 3 | 1 | | 1.26 | 0.66 | | 2.1 | 1.1 | | | | |
| BLENDS | 3 | | 8 | 1 | | 4.75 | 0.34 | | 1.63 | | | |
| | 1 | | 5 | 0.25 | | 1.25 | — | | — | | | |
| | 1 | | 9 | 0.14 | | 1.25 | — | | — | | | |
| | 2 | | 3 | 0.83 | | 1.25 | — | | — | | | |
| | | 1 | 5 | | 0.25 | 1.25 | | — | — | | | |
| | | 1 | 9 | | 0.23 | 2.065 | | — | — | | | |
| | | 1 | 8 | | 0.59 | 5.38 | | 0.25 | 2.25 | | 0.25 | 2.25 |
| TERNARY | 3 | 1 | 8 | 0.74 | 0.39 | 3.5 | 0.47 | 0.25 | 2.25 | 0.47 | 0.25 | 2.25 |
| BLENDS | 1 | 0.5 | 7 | 0.9 | 0.45 | 6.3 | 0.36 | 0.18 | 2.52 | 0.36 | 0.18 | 2.52 |
| | 3 | 1.5 | 11 | 0.5 | 0.25 | 1.83 | 0.36 | 0.18 | 1.32 | 0.36 | 0.18 | 1.32 |
| | 3 | 1.5 | 14 | 0.5 | 0.25 | 2.33 | | | | | | |
| | 5 | 2 | 5 | >2.75 | >1.1 | >2.75 | 0.8 | 0.32 | 0.38 | 1.3 | 0.52 | 1.3 |
| | 3 | 2 | 14 | 0.48 | 0.32 | 2.24 | | | | | | |
| | 3.5 | 1.5 | 11 | 1.38 | 0.59 | 4.33 | | | | | | |
| | 3.5 | 2.5 | 14 | 0.54 | 0.39 | 2.17 | | | | | | |
| | 3 | 2 | 1 | | | | 1.65 | 1.1 | 0.55 | 3 | 2 | 1 |
| | 3 | 1 | 4 | | | | 0.96 | 0.32 | 1.28 | 1.35 | 0.45 | 1.8 |
| | 4 | 1 | 2 | | | | 1.8 | 0.45 | 0.9 | 2.36 | 0.59 | 1.18 |
| | 4 | 1 | 7 | | | | 1.54 | 0.39 | 2.7 | 1.8 | 0.45 | 3.15 |
| | 5 | 0.5 | 7.5 | | | | 3.2 | 0.32 | 4.8 | 5.9 | 0.59 | 8.85 |

TABLE 3
Synergy Index calculation for binary blends
of carvacrol, thymol and salycilaldehyde.

| Composition (proportion) | | | Composition (percentage) | | | Synergy Index | | P- value | |
|---|---|---|---|---|---|---|---|---|---|
| Carva- | Thy- | Salicylal- | Carva- | Thy- | Salicylal- | S. | E. | S. | E. |
| crol | mol | dehyde | crol | mol | dehyde | aureus | coli | aureus | coli |
| 3 | | 8 | 27.27 | | 72.73 | 1.48 | 0.46 | — | 0.000 |
| 1 | | 5 | 17 | | 83 | 0.38 | — | 0.000 | — |
| 1 | | 9 | 10 | | 90 | 0.33 | — | 0.000 | — |
| 2 | | 3 | 40 | | 60 | 0.66 | — | 0.000 | — |
| | 1 | 5 | 17 | | 83 | 0.49 | — | 0.000 | — |
| | 1 | 9 | 10 | | 90 | 0.64 | — | 0.000 | — |
| | 1 | 8 | | 11.11 | 88.89 | 1.67 | 0.6 | — | 0.000 |

Synergy index = CM a/CS a + CM b/CS b
CM a = MIC of compound a to achieve a complete kill when is use in combination with antimicrobial b
CS a = MIC of compound a required to achieve a complete kill when is used alone.
CM b = MIC of compound b to achieve a complete kill when is use in combination with antimicrobial a
CS b = MIC of compound b required to achieve a complete kill when is used alone.
p-value is <0.05 means that there is a significant difference between the SI value and 1.00.

TABLE 4
Synergy Index calculation for ternary blends of carvacrol, thymol and salycilaldehyde.

| Composition (proportion) | | | Composition (percentage) | | | Synergy Index | | | P- value | | |
|---|---|---|---|---|---|---|---|---|---|---|---|
| Carva- | Thy- | Salicylal- | Carva- | Thy- | Salicylal- | S. | E. | P. | S. | E. | P. |
| crol | mol | dehyde | crol | mol | dehyde | aureus | coli | aeruginosa | aureus | coli | aeruginosa |
| 3 | 1 | 8 | 25 | 8.33 | 66.67 | 1.44 | 0.76 | 1.12 | N/A | 0.000 | N/A |
| 1 | 0.5 | 7 | 11.76 | 5.88 | 82.35 | 2.16 | 0.74 | 1.21 | N/A | 0.000 | N/A |
| 3 | 1.5 | 11 | 19.35 | 9.68 | 70.97 | 0.85 | 0.49 | 0.67 | 0.001 | 0.000 | 0.000 |
| 3 | 1.5 | 14 | 16.22 | 8.11 | 75.68 | 0.96 | Na | Na | 0.020 | Na | N/A |
| 5 | 2 | 5 | 41.67 | 16.67 | 41.67 | >2.89 | 0.51 | 0.87 | N/A | 0.000 | 0.002 |
| 3 | 2 | 14 | 15.79 | 10.53 | 73.68 | 0.99 | Na | Na | 0.225 | Na | N/A |
| 3.5 | 1.5 | 11 | 21.88 | 9.38 | 68.75 | 2.11 | Na | Na | N/A | Na | N/A |
| 3.5 | 2.5 | 14 | 17.5 | 12.5 | 70 | 1.07 | Na | Na | N/A | Na | N/A |
| 3 | 2 | 1 | 50 | 33.33 | 16.67 | Na | 1.22 | 1.29 | Na | N/A | N/A |
| 3 | 1 | 4 | 37.5 | 12.5 | 50 | Na | 0.75 | 1.08 | Na | 0.000 | N/A |
| 4 | 1 | 2 | 57.14 | 14.29 | 28.57 | Na | 1.01 | 0.97 | Na | N/A | 0.035 |
| 4 | 1 | 7 | 33.33 | 8.33 | 58.33 | Na | 1.28 | 1.74 | Na | N/A | N/A |
| 5 | 0.5 | 7.5 | 38.46 | 3.85 | 57.69 | Na | 2.24 | 0.93 | Na | N/A | 0.007 |

Synergy index = CM a/CS a + CM b/CS b + CM c/CS c
CM a = MIC of compound a to achieve a complete kill when is use in combination with antimicrobial b and c
CS a = MIC of compound a required to achieve a complete kill when is used alone.
CM b = MIC of compound b to achieve a complete kill when is use in combination with antimicrobial a
CS b = MIC of compound b required to achieve a complete kill when is used alone.
p-value is <0.05 means that there is a significant difference between the SI value and 1.0

A wide range of ternary combinations of carvacrol, thymol and salicylaldehyde (Carvacrol 11—57%; Thymol 3—17%; Salicylaldheyde 28—85%) have shown a synergistic antimicrobial activity against two gram negative bacteria E. Coli and P. aeruginosa, and the gram positive bacteria, S. aureus. Out of this ranges the activity antimicrobial activity of the ternary combinations decreases significantly In relation to the antimicrobial activity against S. aureus:
The ternary combinations of carvacrol, thymol and salicylaldehyde in proportions 3:1.5:11 and 3:1.5:14 respectively presented synergistic effect with p-values lower than 0.05 indicating that there is a significant difference between the values of SI related to the cited proportions and the value 1.00.

In relation to the antimicrobial activity against E. coli:
The ternary combinations of carvacrol, thymol and salicylaldehyde in proportions 3:1:8 1:0.5:7, 3:1.5:11, 5:2:5 and 3:1:4 respectively presented synergistic effect with p-values lower than 0.05 indicating that there is a significant difference between the values of SI related to the cited proportions and the value 1.00.

In relation to the antimicrobial activity against P. aeruginosa:
The ternary combinations of carvacrol, thymol and salicylaldehyde in proportions 3:1.5:11 5:2:5 4:1:2 and 5:0.5:7.5 presented synergistic effect. This is a very remarkable result, as P. aeruginosa is a particularly resistant bacterial species.
Binary blends of carvacrol/salicylaldehyde and thymol/salicylaldehyde have shown a synergistic antimicrobial activity against the gram negative bacteria E. Coli, and the gram positive bacteria S. aureus.

### Example 2

### Coating Formulations

The coating formulations were prepared as follows:

Carvacrol (C), Thymol (T) and Salicylaldehyde (SA) (ratio 3:1:8) were added to a polymer matrix (10 wt. %) previously dissolved in a food contact solvent. If necessary, plasticizer and/or antifog additive were added. The amount of the mixture of active compounds was 10 wt % respect to the amount of polymer matrix in the solution.

The polymer films containing carvacrol, thymol and salicylaldehyde were prepared as follows:

The mixture was applied to a PP/PA polymer substrate by using a laboratory coating machine (ELCOMETER automatic film applicator with sample temperature control and different transverse speeds) at ambient temperature. After the application, films were dried at ambient temperature for 2 hours. The active films obtained were, in terms of transparency and gloss, equivalent to conventional films.

The amount of active compounds present in the films after processing was quantified by using a Gas Chromatograph coupled to a Mass Spectrometer.

TABLE 5
Different coating formulations used for the preparation of sample films.
Different coating formulations used for the preparation of sample films

| | | | | | Active compounds post | | |
|---|---|---|---|---|---|---|---|
| | | | | | processing amount | | |
| | Antimicrobial | Plasticizer | | Polymer matrix | (% remanent) | | |
| Formulation | agent | (% w/w) | Solvent | (% w/w) | C | T | SA |
| 1 | C/T/SA (3:1:8) | Tributyl citrate (2%) | Ethyl acetate | PS (10%) | 35.1 | 44.2 | 1.4 |
| 2 | C/T/SA (3:1:8) | | Ethyl acetate | PLA (15%) | 100 | 100 | 33.8 |

As is shown in Table 5, the active compounds remain in the films after the processing. This proves the suitability of the incorporation of the antimicrobial composition to films.

### Example 3

### In Vivo Assays

The polymer films containing carvacrol, thymol and salicylaldehyde were prepared as follows:

Carvacrol, Thymol and Salicylaldehyde (ratio 3:1:8) were added to a polystyrene (10 wt. %) solution in ethyl acetate as a solvent. Plasticizer was added at 2 wt. %. The amount of the mixture of active compounds was 10 wt % respect to the amount of polymer matrix in the solution. The mixture was applied to a PP/PA polymer substrate by using a laboratory coating machine at ambient temperature. After the application, films were dried at ambient temperature for 2 hours.

The active films obtained were, in terms of transparency and gloss, equivalent to conventional films.

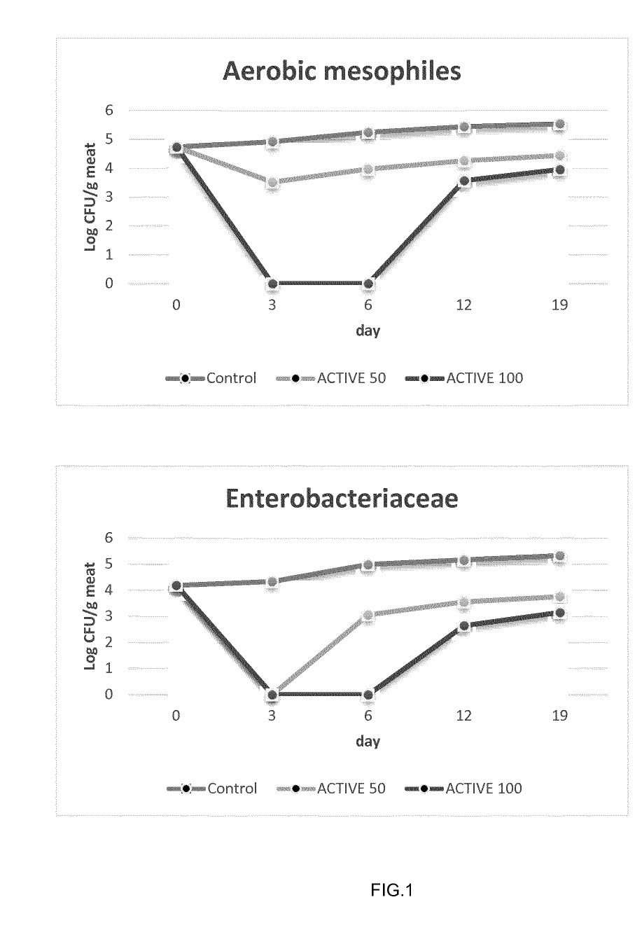

The antimicrobial effectiveness of the active films was tested against two representative groups of microorganisms, aerobic mesophiles and enterobacteriaceae. The results illustrated in FIG. 1 show a significative antibacterial effect of the active films on fresh beefsteaks. In some cases (ACTIVE 100, aerobic mesophiles) beefsteaks do not show bacterial growth before the day 12.

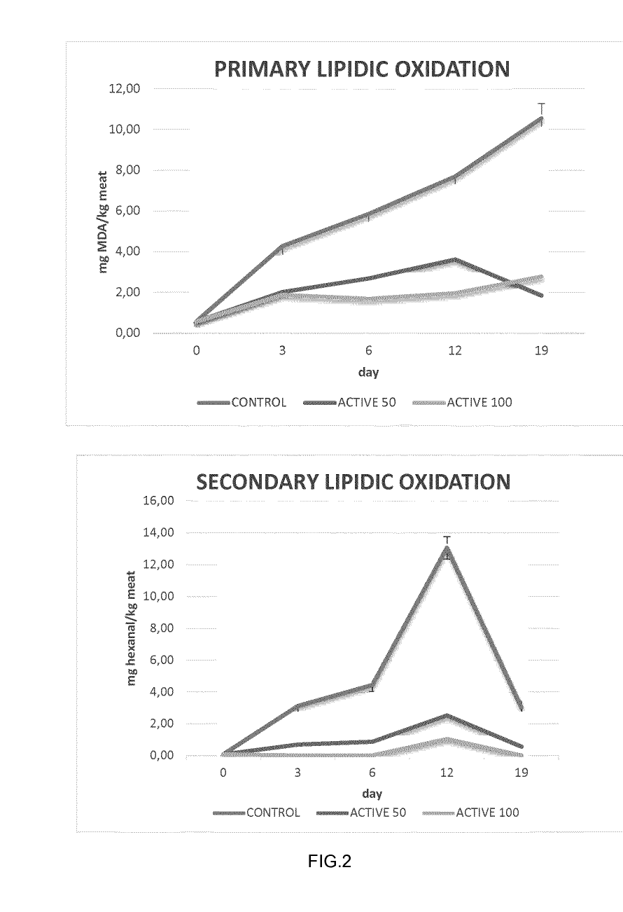

The antioxidant effectiveness of the active films was determined by TBA test (primary lipidic oxidation) and by hexanal test (secondary lipidic oxidation). The results illustrated in FIG. 2 show a marked antioxidant activity of the active films on fresh beefsteaks.

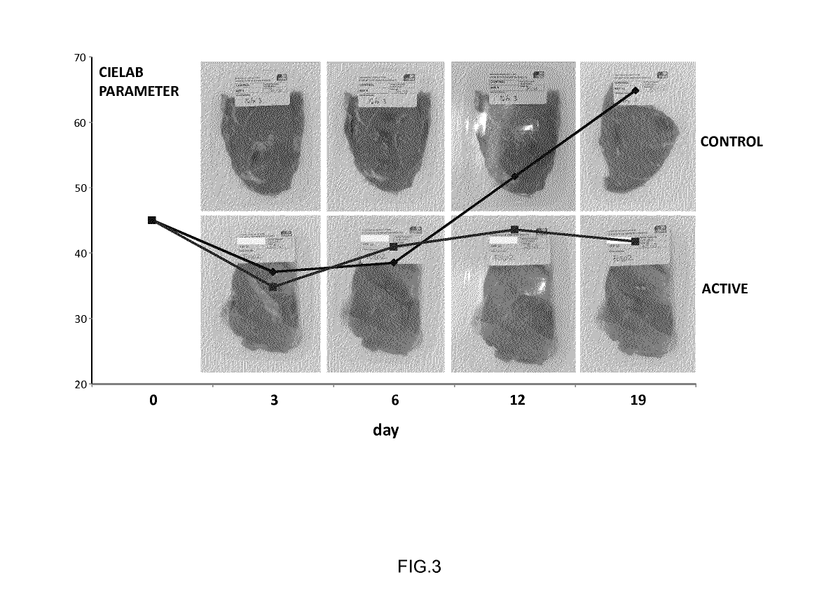

Lastly, it can also be seen (FIG. 3) that the packages featuring the active formulation of the invention are able to preserve the color of packaged meat for much longer periods of time.

### REFERENCES CITED IN THE APPLICATION

Quintavalla S. et. al. “Antimicrobial food packaging in meat industry” Meat Science 2002, vol. 62, pp. 373-380

Gutiérrez L., et. al. “Effect of mixed antimicrobial agents and flavors in active packaging films” J. Agric. Food Chem. 2009, vol. 57, pp. 8564-8571

Gutierrez L. et. al. “New approach to study the mechanism of antimicrobial protection of an active packaging” Food Borne Pathogens and Disease 2010, vol. 7, n. 9, pp. 1063-1069

1. An antimicrobial composition for organic product packaging selected from the group consisting of:
a) a combination consisting of carvacrol, thymol and salicylaldehyde;
b) a combination consisting of thymol and salicylaldehyde at a ratio thymol:salicylaldehyde of from 1:2 to 1:9 in weight;
c) a combination consisting of carvacrol and salicylaldehyde at a ratio carvacrol:salicylaldehyde of from 1:2 to 1:9 in weight;
d) a combination consisting of carvacrol, thymol,salicylaldehyde, and other components and/or excipients devoid of any antimicrobial activity;
e) a combination consisting of thymol, salicylaldehyde at a ratio thymol:salicylaldehyde of from 1:2 to 1:9 in weight, and other components and/or excipients devoid of any antimicrobial activity; and
f) a combination consisting of carvacrol, salicylaldehyde at a ratio carvacrol:salicylaldehyde of from 1:2 to 1:9 in weight; and other components and/or excipients devoid of any antimicrobial activity.

2. The antimicrobial composition for organic product packaging of claim 1, which is the combination of carvacrol, thymol and salicylaldehyde, or the combination of carvacrol, thymol, salicylaldehyde and other components and/or excipients devoid of any antimicrobial activity.

3. The antimicrobial composition for organic product packaging of claim 1, which is the combination of thymol and salicylaldehyde at a ratio thymol:salicylaldehyde of from 1:2 to 1:9 in weight, or the combination is thymol and salicylaldehyde at a ratio thymol:salicylaldehyde of from 1:2 to 1:9 in weight, and other components and/or excipients devoid of any antimicrobial activity.

4. The antimicrobial composition for organic product packaging of claim 1, which is the combination of carvacrol and salicylaldehyde at a ratio carvacrol:salicylaldehyde of from 1:2 to 1:9 in weight, or the combination is cavacrol and salicylaldehyde at a ratio carvacrol:salicylaldehyde of from 1:2 to 1:9 in weight, and other components and/or excipients devoid of any antimicrobial activity.

5. The antimicrobial composition according to claim 2, wherein the concentration of carvacrol:thymol:salicylaldehyde is:
carvacrol from 5% to 50%;
thymol from 3% to 20%; and
salicylaldehyde from 28% to 90%,
in weight with respect to the total concentration of carvacrol, thymol and salicylaldehyde.

6. The antimicrobial composition according to claim 5, wherein the concentration of carvacrol:thymol:salicylaldehyde is:
carvacrol from 11% to 42%;
thymol from 5% to 17%; and
salicylaldehyde from 41% to 82%,
in weight with respect to the total concentration of carvacrol, thymol and salicylaldehyde.

7. The antimicrobial composition according to any of the claims 1-6, wherein the organic product is food.

8. An active formulation for organic product packaging comprising a polymeric matrix and the antimicrobial composition of any of the claims 1-7.

9. The active formulation according to claim 8, wherein the polymeric matrix comprises polysterene, polylactic acid, ethylene-vinyl-alcohol, polyamides, polyolefins, celluloses, waxes, paraffins, or a mixture thereof.

10. The active formulation according to any one of claims 8-9, wherein the antimicrobial composition is interspersed in the polymeric matrix.

11. The active formulation according to any of the claims 8-10, which is an active coating for food packaging.

12. An organic product packaging substrate coated with the active formulation according to anyone of claims 8-11.

13. The organic product packaging substrate according to claim 12, wherein the packaging substrate is a lid, a tray, a film, a paper, a bag, or a pad.

14. An organic product package comprising the organic product packaging substrate according to any one of claims 12-13.

15. The organic product package of claim 14, which is a food package.

16. A process for preparing the active formulation as defined in any of the claims 8-11, comprising:
a1) providing a polymer matrix and optionally dissolving the polymeric matrix in at least one solvent;
a2) Optionally, incorporating at least one plasticiser;
a3) Optionally incorporating at least one anti-fog compound; and
a4) Incorporating the antimicrobial combination as defined in any of the claims 1-7.

17. The process for preparing the active formulation according to claim 16, wherein in step a2) the at least one plasticiser is tert-butyl citrate, polyadipate or glycerol.

18. The process for preparing the active formulation according to anyone of claims 16-17, wherein in step a3) the at least one anti-fog compound is sodium lauryl sulphate, glycerol or an ethoxy-amine.

19. A process for preparing the organic product packaging substrate according to anyone of claims 12-13, comprising the steps of:
a) Optionally treating the surface of the organic product packaging substrate, to be coated with the active formulation as defined in any one of claims 8-10, with a corona treatment;
b) Applying the active formulation to the organic product packaging substrate by coating, impression, dipping or spraying; and
c) Drying the organic product packaging substrate.

20. The process of claim 19, wherein in step b), the coating comprises roller printing, flexography, ink jet printing or rotogravure.

21. The process of any one of claims 19-20, wherein the formulation is deposited on the whole surface of the substrate, or alternatively, only on some areas of the surface of the substrate.

22. Use of the active formulation for organic product packaging of any of the claims 8-11, for extending the shelf-life of organic product susceptible of being colonized by microbes.

23. The use according to claim 22, wherein the organic product susceptible of being colonized by microbes is a meat-based product.
